(19) United States
(12) Patent Application Publication
(10) Pub. No.: US 2015/0066555 A1
(43) Pub. Date: Mar. 5, 2015

(54) MEASURING USER PRODUCTIVITY IN PLATFORM DEVELOPMENT

(71) Applicants: Kesavaprakash Vasudevan, Heidelberg (DE); Matthias Steiner, Koeln (DE)

(72) Inventors: Kesavaprakash Vasudevan, Heidelberg (DE); Matthias Steiner, Koeln (DE)

(73) Assignee: SAP AG, Walldorf (DE)

(21) Appl. No.: 14/011,584

(22) Filed: Aug. 27, 2013

(51) Int. Cl. G06Q 10/06

(52) U.S. Cl. CPC G06Q 10/063114
USPC 705/7.15

(57) ABSTRACT

The embodiments provide a system for measuring user productivity in developing a business process using one or more development tools. The system may include a productivity tacking unit configured to provide a user productivity model for measuring user productivity. The user productivity model may identify at least one business function associated with a process to be implemented by one or more development tools, at least one composition pattern, and a plurality of effort drivers associated with the at least one composition pattern. The productivity tracking unit is configured to receive development tracking information based on the user productivity model. The system may also include a report generator unit configured to generate at least one report characterizing the user productivity in developing at least a portion of the process based on the user productivity model and the development tracking information.

### BACKGROUND

In platform development, several development tools and services may be utilized to assist different users or user groups to develop meaningful solutions for their business problems. Platforms may reduce the total cost of development (TCD) and total cost of ownership (TCO) (which includes the maintenance costs and other costs relating to ownership) by providing a unified experience in using the development tools and services. However, one of the challenges with platform development is quantifying and measuring productivity of users using the development tools and services for implementing a process to solve a business problem.

Generally, a platform (and corresponding tools and services) may provide multiple options to accomplish tasks 107 of a business process, and sometimes, even multiple tools have overlapping functions (e.g., deployment using integrated development environment (IDE) or deploying a specific tool). The use of multiple tools having overlapping functions may be necessary in order to address different user groups or different expertise levels. In a typical platform (e.g., JEE platform), situations may occur which makes it relatively difficult to quantify or measure user productivity across different stages of application development, which is constructed using this platform and corresponding tools.

Conventional productivity tracking methods cannot identify and measure user productivity for solutions developed in a platform from an end-to-end perspective (e.g., Blueprint-implementation-rollout-operations), which may lead to a potential waste of resources by not addressing the right issues. For example, without meaningful user productivity measurements, developmental teams may spend more time over optimizing one particular tool or component instead of focusing on the weakest link. Meaningful user productivity measurements are even more important when a new platform/tool will be released to market, where customer feedback may be limited.

### SUMMARY

The embodiments provide a system for measuring user productivity in developing a business process using one or more development tools. The system may include at least one processor, and a non-transitory computer-readable storage medium including instructions executable by the at least one processor. The instructions may be configured to implement a productivity tacking unit configured to provide a user productivity model for measuring user productivity. The user productivity model may identify at least one business function associated with a process to be implemented by one or more development tools, at least one composition pattern representing a typical task that occurs in application design associated with the at least one business function, and a plurality of effort drivers associated with the at least one composition pattern. Each effort driver may provide a different characterization of effort required by a development tool to accomplish the at least one composition pattern. The productivity tracking unit is configured to receive development tracking information based on the user productivity model. The development tracking information may include time information indicating an amount of time spent for one or more of the plurality of effort drivers. The system may also include a report generator unit configured to generate at least one report characterizing the user productivity in developing at least a portion of the process based on the user productivity model and the development tracking information.

In one example, the user productivity model may also indicate a development tool used for implementing the at least one composition pattern. The user productivity model may be provided in an Excel format. The productivity tracking unit may be configured to receive development tracking information embedded in the Excel format of the user productivity model.

In one example, the plurality of effort drivers may include a first effort driver related to requirements understanding, a second effort driver related to architecture or design of the process, and a third effort driver related to development of business logic for the process. The time information may indicate the amount of time spent by a user for the requirements understanding, the architecture or design of the process, and the development of business logic for the process.

The report generator unit may be configured to receive additional information related to at least one of user roles, team information identifying a group of users, and organizational information indicating one or more organizational departments, and the report generator unit is configured to generate the at least one report based on the additional information, the user productivity model, and the development tracking information.

The productivity tracking unit may be configured to receive first development tracking information related to a first version of a development tool and second development tracking information related to a second version of a development tool, and the report generator unit is configured to generate a report identifying development effort categorized by composition patterns or higher-level categories representing groups of composition patterns for the first version and the second version.

In one example, the at least one report may include a report specifying an amount of effort categorized by the plurality of effort drivers for at least one group of composition patterns.

The embodiments may provide a method for measuring user productivity in developing a business process using one or more development tools. The method may include providing a user productivity model for measuring user productivity. The user productivity model may identify at least one business function associated with a process to be implemented by one or more development tools, at least one composition pattern representing a typical task that occurs in application design associated with the at least one business function, and a plurality of effort drivers associated with the at least one composition pattern. Each effort driver may provide a different characterization of effort required by a development tool to accomplish the at least one composition pattern. The method may also include receiving development tracking information based on the user productivity model. The development tracking information may include time information indicating an amount of time spent for one or more of the plurality of effort drivers. Also, the method may include generating at least one report characterizing the user productivity in developing at least a portion of the process based on the user productivity model and the development tracking information.

In one example, the user productivity model may be provided in an Excel format, and the receiving step may receive the development tracking information embedded in the Excel format of the user productivity model.

In one example, the plurality of effort drivers may include a first effort driver related to requirements understanding, a second effort driver related to architecture or design of the process, and a third effort driver related to development of business logic for the process, and the time information may indicate the amount of time spent by one or more users for the requirements understanding, the architecture or design of the process, and the development of business logic for the process.

The method may further include receiving additional information related to at least one of user roles, team information identifying a group of users, and organizational information indicating one or more organizational departments, where the generating step may generate the at least one report based on the additional information, the user productivity model, and the development tracking information.

In one example, the receiving step may receive first development tracking information related to a first version of a development tool and second development tracking information related to a second version of a development tool, and the generating step may generate a report identifying development effort categorized by composition patterns or higher-level categories representing groups of composition patterns for the first version and the second version.

The at least one report may include a report specifying an amount of effort categorized by the plurality of effort drivers for at least one group of composition patterns. The user productivity model also may indicate a development tool used for implementing the at least one composition pattern.

The embodiments may provide a non-transitory computer-readable medium storing instructions that when executed cause a system to provide a user productivity model for measuring user productivity. The user productivity model may identify at least one business function associated with a process to be implemented by one or more development tools, at least one composition pattern representing a typical task that occurs in application design associated with the at least one business function, and a plurality of effort drivers associated with the at least one composition pattern. Each effort driver may provide a different characterization of effort required by a development tool to accomplish the at least one composition pattern. The instructions may cause the system to receive development tracking information based on the user productivity model. The development tracking information may include time information indicating an amount of time spent for one or more of the plurality of effort drivers. The instructions may cause the system to generate at least one report characterizing the user productivity in developing at least a portion of the process based on the user productivity model and the development tracking information.

The user productivity model may be provided in an Excel format, and the instructions may include instructions to receive development tracking information embedded in the Excel format of the user productivity model.

In one example, the plurality of effort drivers may include a first effort driver related to requirements understanding, a second effort driver related to architecture or design of the process, and a third effort driver related to development of business logic for the process, and the time information may indicate the amount of time spent by a user for the requirements understanding, the architecture or design of the process, and the development of business logic for the process.

The instructions may include instructions to receive additional information related to at least one of user roles, team information identifying a group of users, and organizational information indicating one or more organizational departments, and to generate the at least one report based on the additional information, the user productivity model, and the development tracking information. In one example, the at least one report may include a report specifying an amount of effort categorized by the plurality of effort drivers for at least one group of composition patterns.

### BRIEF DESCRIPTION OF THE DRAWINGS

FIG. 1 illustrates a system for measuring user productivity in developing a process using one or more development tools according to an embodiment;

FIG. 2 illustrates an example of a portion of a user productivity model utilized by the system of FIG. 1 according to an embodiment;

FIG. 3 illustrates an example of a portion of the user productivity model having composition patterns and effort drivers for a business function according to an embodiment;

FIG. 4 illustrates a portion of a report including a graph generated by the system of FIG. 1 according to an embodiment

FIG. 5 illustrates a portion of a report including a graph generated by the system of FIG. 1 according to another embodiment; and

FIG. 6 is a flowchart illustrating example operations of the system of FIG. 1 according to an embodiment.

### DETAILED DESCRIPTION

The embodiments provide a mechanism to identify and measure user productivity for solutions developed by development tools in order to derive meaningful user productivity data regarding the implementation of a business process. In contrast to conventional approaches, the embodiments provide a structured breakdown (e.g., a user productivity model) of user functions and efforts required to accomplish the user functions, as well as the repeatability of benchmarking comparisons to measure and compare against improvements in future releases.

The user productivity model may be defined based on composition patterns that represent typical tasks that regularly occur in process design and effort drivers that characterize the various kinds of efforts required by development tools to accomplish the composition patterns. In one example, the effort drivers may reflect the time spent regarding architecture design, development of business logic, layout, refactoring, issue tracking, learning, administration, setup or configuration, tests, meetings, and/or generally any type of physical or mental energy related to application design provided by developers or administrators (generally referred to as users).

According to one example methodology, a business scenario that needs to be implemented using a platform or development tool is identified. The business scenario may be modeled as a process having a plurality of process steps. Then, the business scenario or process is converted to business functions, which are standardized steps, actions, functions, or use cases to develop the business scenario or process.

In further detail, a business process including a plurality of process steps may be implemented using development tools such as Composite Application Framework, Adobe Integration, Guided Procedures, Java Server, Net/Weaver Development Infrastructure (NWDI), Net/Weaver Developer Studio (NWDS), Visual Composer, Web Dynpro, Portal, and/or Advanced Business Application Programming (ABAP), or generally any type of development tool typically used to implement a business process. Also, the development tools may encompass any type of computing platform such as Java platform, NetWeaver, etc. Based on the process steps, a number of business functions may be defined in order to carryout the process steps. For example, a process step may relate to entering a claim for a claims management process. The business functions for carrying out this process step may include an offline form submission (e.g., the customer downloads a PDF version of the claim submission form) or an online claim creation (e.g., the customer submits the claim via an on-line submission page). In order to accomplish each of these business functions, various tasks must be performed. With respect to the business function relating the offline form submission, the tasks may include creating a form template, validating the form data, and creating external services for data validation.

To execute each of the tasks, there are various factors that are to be considered such as understanding of the requirements, design of required functionalities, tool awareness to execute this task, etc. Basically, these various factors are the efforts which attribute to the cost of development or maintenance.

According to the embodiments, one or more tasks may be grouped (converted) into a composition pattern that is identifiable in a given platform. For example, in a composition platform such as NetWeaver (NW) Java Server, there may be typical issues that regularly occur in composite application design and development, and these issues may be referred to as composition patterns. In other words, a composition pattern may describe a typical task which regularly occurs in application design and development. Generally, some examples of composition patterns may include offline-form based process, UI-based process, Value Help, dynamic assignment of processor, etc. However, the specific type of composition pattern may widely vary depending on the context of the process to be implemented. Also, a composition pattern may describe a practice (e.g., best practice) how to accomplish that task via a solution sketch and a reference implementation.

According to the embodiments, each composition pattern is associated with a set of effort drivers. For example, the effort drivers may describe the typical effort required by the development tools for implementing each composition pattern and/or the internal and external factors that impact the effort in implementation of each composition pattern. Generally, some examples of effort drivers may include tool learning, business process deign, UI mockup, development, project management, etc. More generally, the effort drivers may refer to the physical or mental energy of a user required to implement a respective composition pattern. Therefore, the user productivity model may identify the business functions for implementation of a particular process (or portion thereof), the associated tasks, the tools, and the composition patterns, and for each composition pattern, the user productivity model may provide the set of effort drivers described above.

A productivity tracking unit may provide the user productivity model to one or more users, which may span across several departments having different levels of expertise. In one example, the user productivity model may be in an Excel spreadsheet format. In response, the productivity tracking unit may receive development tracking information. The development tracking information may include time information indicating the amount of time spent by the developer across one or more of the effort drivers. In this way, the development tracking information may indicate where the time was spent in implementing a certain composition pattern. For example, the development tracking information may specify the amount of effort (e.g., in terms of minutes, hours, days, etc.) for each relevant effort driver.

Then, a report generator unit may generate one or more reports based on the development tracking information and the user productivity model. For example, the report generator unit may analyze the development tracking information within the context of the user development model, and generate reports identify how much the quality and robustness of a platform helps in improving user productivity. For example, the report generator unit may analyze the time across the effort drivers, and develop one or more reports that characterize the total development effort, development effort categorized by composition pattern or effort driver, development effort across multiple versions of tools/platforms.

Further, the report generator unit may obtain additional information such as user roles, team information identifying a group of users, and organization information indicating one or more organization departments, and analyze the development tracking information in view of the additional information to produce one or more reports that characterizes the user productivity across user roles, developmental teams, or organizational units. However, generally, the report generator unit may incorporate any type of information related to assessing user productivity, and generate reports based on this information and the development tracking information. These and other features are further explained with reference to the figures.

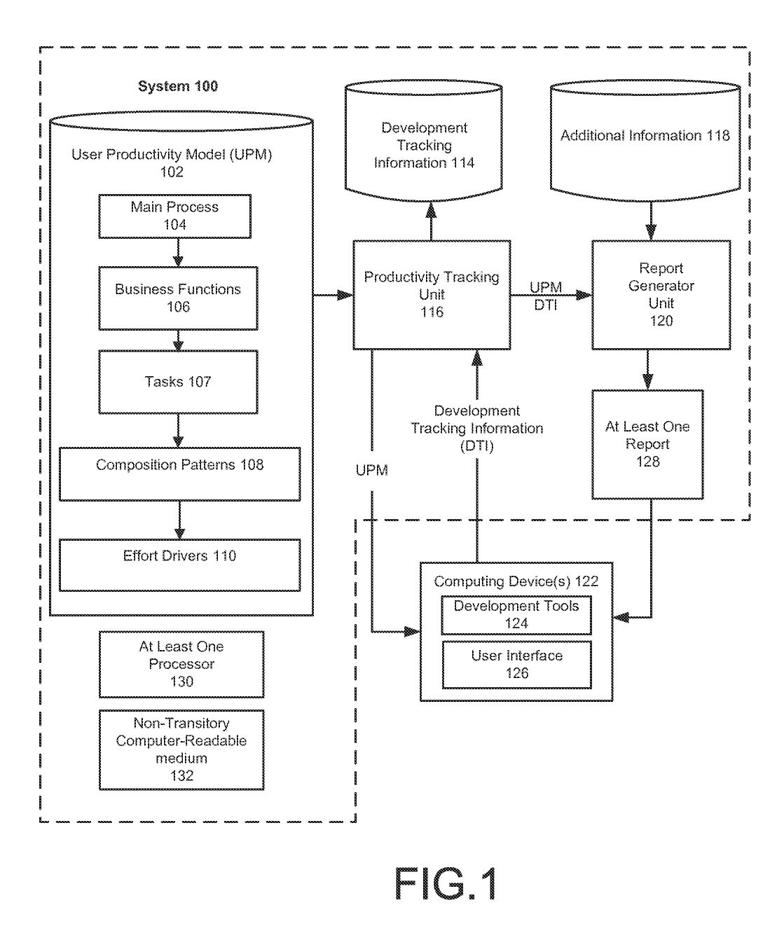

FIG. 1 illustrates a system 100 for measuring user productivity in developing a business process using one or more development tools according to an embodiment. The system 100 may include a productivity tracking unit 116 configured to provide a user productivity model (UPM) 102 to one or more computing device(s) 122, which may span across multiple organizations, expertise levels, or users/user groups. Based on the user productivity model 102, the productivity tracking unit 116 may receive development tracking information 114 (DTI) from the one or more computing device(s) 122. The system 100 may include a report generator unit 120 configured to generate at least one report 128 based on the development tracking information 114 and the user productivity model 102. Also, the system 100 may include one or more database storing the user productivity model 102, the development tracking information 114, and additional information 118 relating to other types of data used for report generation.

The system 100 may include at least one processor 130, and a non-transitory computer-readable medium 132. The non-transitory computer readable medium 132 may include instructions, that when executed by the at least one processor 130, are configured to implement the components and/or functionalities of the system 100 including the productivity tracking unit 116, and the report generator unit 120, as further described below. Further, the system 100 may include other components or units known to one of ordinary skill in the art.

The non-transitory computer readable medium 132 may include one or more non-volatile memories, including by way of example semiconductor memory devices, e.g., EPROM, EEPROM, and flash memory devices; magnetic disks, e.g., internal hard disks or removable disks, magneto optical disks, and CD ROM and DVD-ROM disks. Besides storing executable instructions, the non-transitory computer-readable medium 132 may also store any type of database structure discussed herein including the databases storing the user productivity model 102, the development tracking information 114, and the additional information 118. Alternatively, the user productivity model 102, the development tracking information 114, and/or the additional information 118 may be associated with a system outside the system 100 having the productivity tracking unit 116 and/or the report generator unit 120, and this information may be accessed by the productivity tracking unit 116 and/or the report generator unit 120. The at least one processor 130 may include any type of special purpose logic circuitry, e.g., an FPGA (field programmable gate array) or an ASIC (application specific integrated circuit).

The computing devices 122 may include any type of computing device having a processor and memory. Also, the computing devices 122 may include one or more development tools 124 that are used to implement a process, and a user interface 126 configured to display at least a portion of the user productivity model 102 and display the at least one report 128. For example, the development tools 124 may include Composite Application Framework, Adobe Integration, Guided Procedures, Java Server, Net/Weaver Development Infrastructure (NWDI), Net/Weaver Developer Studio (NWDS), Visual Composer, Web Dynpro, Portal, and/or Advanced Business Application Programming (ABAP), or generally any type of development tool typically used to implement a business process. Also, the development tools may encompass any type of computing platform such as Java platform, NetWeaver, etc. Also, it is noted that the development tools 124 may be associated with the system 100 (or any other system), and accessed via the computing devices 122.

In one example, the productivity tracking unit 116 may obtain the user productivity model 102 from the database storing the user productivity model 102. The user productivity model 102 may include a main process 104, tasks 107, business functions 106, composition patterns 108, and/or effort drivers 110. Also, it is noted that the user productivity model 102 may include other types of information such as tool information indicating the relevant development tool 124, as well as other information such as mapping information that maps the above-described information to each other.

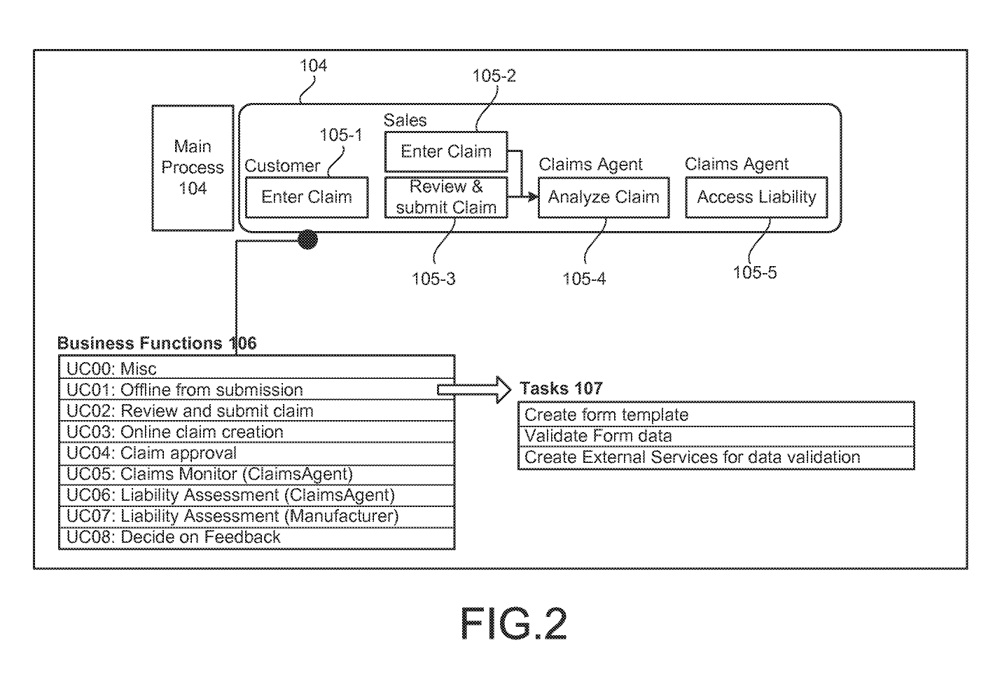

In one example, the user productivity model 102 may be associated with the main process 104. The main process 104 may relate to any type of high-level business process, and, generally, may include a plurality of process steps (e.g., process steps 105 shown in FIG. 2). The main process 104 may be associated with one or more of the business functions 106. Each business function 106 may be a standardized step, action, function, or use case to develop one or more portions of the main process 104. In this context, some of the business functions 106 may be applicable across different portions of the main process 104, as well as other main processes 104. In one example, the process steps of the main process 104 (or associated tasks 107) may be grouped (converted) to one or more of the business functions 106. The business functions 106 may include any number of business functions 106 related to implementation of the process steps of the main process 104. In order to accomplish each of these business functions 106, various tasks 107 must be performed. Each task 107 may be considered a more-specific step, action, or function that may be performed in order to implement the corresponding business function 106. The relationships between the main process 104, the business functions 106, and the tasks 107 are further detailed in FIG. 2.

FIG. 2 illustrates an example of a portion of the user productivity model 102 utilized by the system 100 according to an embodiment. For example, the user productivity model 102 may specify the main process 104, the business functions 106 associated with the main process 104, and the tasks 107 associated with the business functions 106. In this example, the main process 104 relates to a claims management process to be developed. Again, this is merely an example, where the embodiments encompass any type of main process 104. The main process 104 of FIG. 2 includes a plurality of process steps 105 (e.g., first process step 105-1, second process step 105-2, third process step 105-3, and fourth process step 105-4). In this example, the first process step 105-1 relates to entering a claim on the customer-side, the second process step 105-2 relates to entering a claim on the sales-side, the third process step 105-3 relates to reviewing and submitting the claim on the sales-side, the fourth process step 105-4 relates to analyzing the claim by the claims agent, and the fifth process step 105-5 relates to assessing the liability of the claim by the claims agent. The embodiments are not limited to the specific characterization of each process step 105 (as well as the following specific examples of the tasks 107, the business functions 108, the composition patterns 108, and the effort drivers 110).

As indicated above, the business functions 106 may provide a list of standardized steps/acts/functions for implementing at least a portion of the main process 104. In this example, the business functions 106 relate to the various functions which need to be completed for implementing the first process step 105-1. With respect to this specific example, the business functions 106 for this first process step 105-1 may include UC00 (an offline form submission), UC01 (Offline form submission), UC02 (Review and Submit claim), UC03 (Online claim creation), UC04 (Claim approval), UC05 (Claims monitor (Claims Agent)), UC06 (Liability Assessment (Claims Agent)), UC07 (Liability Assessment (Manufacturer)), and UC08 (Decide on Feedback 106-9). Also, in this specific example, each business function 106 is identified by an identifier (e.g., UC01-UC08).

Referring to FIG. 2, each business function 106 may be associated the tasks 107. Generally, the tasks 107 are performed by one or more users with the aid of the development tools 124 and often require mixed expertise levels. In this specific example, the tasks 107 associated with the first business function 106-1 may include create form template, validate form data, and create external services for data validation. To execute each of the tasks 107, there are various factors to be considered such as an understanding of requirements, design of required functionality, tool awareness to execute this task, etc. Basically, these various factors are the effort drivers 110, which attribute to the cost of development or maintenance.

Referring back to FIG. 1, a set of tasks (e.g., such as the tasks 107) may be grouped based on a pattern that is identifiable in a given development tool 124. For example, in a composition platform such as NW Java Server, there may be typical issues that regularly occur in composite application design and development, and these issues may be referred to as composition patterns 108. In other words, a composition pattern 108 may describe a typical task which regularly occurs in application design and development.

The user productivity model 102 may include the composition patterns 108 relating to the business functions 106. In one example, each business function 106 may be associated with one or more composition patterns 108. In other words, one or more tasks 107 may be executed to implement a respective business function 106, and in order to carry out the tasks 107, one or more composition patterns 108 may be identified. As such, multiple composition patterns 108 may relate to the same business function 106, but are for different tasks 107 within the context of this business function 106.

Again, each composition pattern 108 may provide a typical issue/problem/solution that regularly occurs in composite application design and development. In other words, a composition pattern 108 may describe a typical task which regularly occurs in application design and development. The specific type of composition pattern may widely vary depending on the context of the main process 104 to be implemented. Also, a composition pattern 108 may describe a practice (e.g., best practice) how to accomplish that task via a solution sketch and a reference implementation.

According to the embodiments, each composition pattern 108 is associated with a set of effort drivers 110. For example, the effort drivers 110 may describe the typical effort required by the development tools 124 for implementing each composition pattern 108 and/or the internal and external factors that impact the effort in implementation of each composition pattern 108. In other words, each effort driver 110 may describe the physical or mental energy provided by a user to implement a particular composition pattern 108 using one or more of the development tools 124.

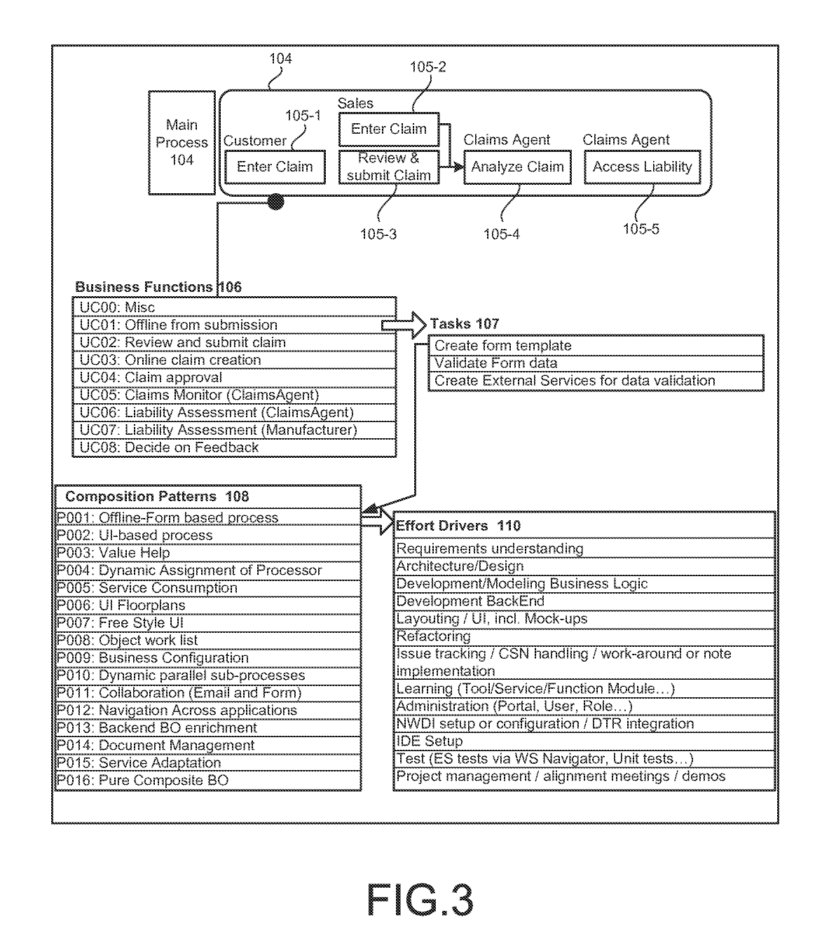

In one example, a first composition pattern 108 may include a set of effort drivers 110 such as a first effort driver 110 through N effort driver 110. However, the embodiments encompass any number of effort drivers 110 associated with a composition pattern 108. Also, it is noted that the same set of effort drivers 110 may be associated with each composition pattern 108. However, the embodiments also encompass one or more different effort drivers 110 for the composition patterns 108 Generally, some examples of the effort drivers 110 may include tool learning, business process deign, UI mockup, development, project management, etc. The relationship between the tasks 107, the composition patterns 108, and the effort drivers 110 are further explained with reference to FIG. 3.

FIG. 3 illustrates an example of a portion of the user productivity model 102 having the composition patterns 108 and effort drivers 110 for a particular business function 106 according to an embodiment. FIG. 3 may be considered a continuation of FIG. 2, which additionally includes the composition patterns 108 and the effort drivers 110. Because the main process 104, the business functions 106, and the tasks 107 were previously described with reference to FIG. 2, the details of these components within the context of FIG. 3 will be omitted for the sake of brevity.

In this example, the first task of the tasks 107 (e.g., create form template) relating to UC01 is associated with a number of composition patterns 108. In this specific example, the composition patterns 108 may include P001 (Offline-Form based process), P002 (UI-based process), P003 (Value Help), P004 (Dynamic assignment of processor), P005 (Service consumption), P006 (UI floorplans), P007 (Free Style UI), P008 (Object Work list), P009 (Business configuration), P010 (dynamic parallel sub-processes), P011 (Collaboration (Email and Form)), P012 (Navigation access application), P013 (backend BO enrichment), P014 (document management), P015 (Service adaptation), and P016 (Pure composite BO).

Each composition pattern 108 may be associated with the set of effort drivers 110. As shown in FIG. 3, the composition pattern 108 related to P001 may be associated with the set of effort drivers 110. In this specific example, the set of effort drivers 110 may include a requirements understanding, architecture or design, development or modeling business logic, development of backend, lay outing or User Interface including mock-ups, refactoring, issue tracking or CSN handling or work-around or note implementation, learning, administration, NWDI setup or configuration, IDE setup, testing, and/or project management.

It is noted that this list of effort drivers 110 is not intended as an exhaustive list, and may include other types of effort drivers 110. Also, the types of effort drivers 110 may be different for one or more composition patterns 108. Generally, each effort driver 110 may refer to the physical or mental energy of a user required to implement a respective composition pattern 108. As such, the characterization of each effort driver 110 may depend on the system administrator, and may widely vary. However, the overall goal remains the same—to manage and track the time of users for implementing a respective composition pattern 108. The break-down of typical user effort into effort drivers 110 (as well as the assignment to the composition patterns 108) facilitates the management and tracking of user productivity into more defined areas (e.g., the effort drivers 110), which leads to the identification of application development or design issues.

Referring back to FIG. 1, the user productivity model 102 may identify the business functions 106 for implementation of a particular process (e.g., the main process 104), the associated tasks 107, and the composition patterns 108, and for each composition pattern 108, the user productivity model 102 may provide the set of effort drivers 110 described above. Additionally, the user productivity model 102 may identify the development tools 124 associated with the composition patterns 108, as well as other information linking the main process 104, the tasks 107, the composition patterns 108, and the effort drivers 110.

In one embodiment, the user productivity model 102 maybe an Excel spreadsheet, which may be based on the following table:

TABLE 1

| | | | | | Effort | |
|---|---|---|---|---|---|---|
| Business | | | | | in | |
| Function | Task | Tool | Pattern | Effort Driver | hours | Remarks |
| UC00: | Composite | Composite | P009: | Requirements | | |
| Misc | Configuration | Application | Business | Understanding | | |
| | | Framework | Configuration | | | |
| | | (CAF) | | | | |
| UC00: | Composite | CAF | P009 | Architecture/ | | |
| Misc | Configuration | | | Design | | |
| UC00: | Composite | CAF | P009 | Learning | | |
| Misc | Configuration | | | | | |
| UC00: | Composite | CAF | P009 | Project | | |
| Misc | Configuration | | | Management | | |
| UC00: | Composite | CAF | P009 | Administration | | |
| Misc | Configuration | | | | | |
| UC00: | Composite | CAF | P009 | Development | | |
| Misc | Configuration | | | of Business | | |
| | | | | Logic | | |
| UC00: | Composite | CAF | P009 | Test | | |
| Misc | Configuration | | | | | |
| UC00: | Composite | CAF | P009 | Issue Tracking | | |
| Misc | Configuration | | | | | |
| UC00: | Composite | CAF | P009 | Refactoring | | |
| Misc | Configuration | | | | | |

It is noted that Table 1 only illustrates a portion of the user productivity model 102. One of ordinary skill in the art could extend this user productivity model 102 for other business functions 106 or configuration patterns 108.

According to the embodiments, the productivity tracking unit 116 may provide the user productivity model 102 to one or more computing devices 122. In one example, the productivity tracking unit 116 may provide the user productivity model 102, over a network (e.g., any conventional wired or wireless communication network), to one or more of the computing devices 122 associated with the relevant users, e.g., developers, administrators, managers, etc. In another embodiment, the productivity tracking unit 116 may provide access to the user productivity model 102 which is stored in the database associated with the system 100.

Once received/accessed at the computing devices 122, the relevant users may provide the development tracking information 114, e.g., the effort in hours, and the remarks, within the context of the user productivity model 102, via the user interface 126. In one example, if the user productivity model 102 is in the Excel spreadsheet format, the user productivity model 102 may be displayed to the user via the user interface 126, and the user may complete the effort in hours and the remarks sections for one or more of the effort drivers 110. For example, if the user has spent 10 hours related to the requirements understanding, the user would enter 10 hours in the Excel spreadsheet associated with the requirements understanding effort driver. Similarly, the user would enter time information for any other relevant effort driver. It is noted that the time information may be specified in other formats besides hours. Also, the user productivity model 102 may be in another format such as any type of spreadsheet format (other than Excel), any type of computer-file format, or any type of computer or network-based format that may be communicated over a network.

Then, the user would submit the user productivity model 102 completed with the development tracking information 114. Accordingly, the productivity tracking unit 116 may receive the development tracking information 114 and store this information in the database associated with storing the development tracking information 114, store this information in the database associated with storing the user productivity model 102, or store this information in any type of database associated with the system 100.

If the user productivity model 102 is within a network-based format, the user may be presented with the user productivity model 102, and then submit the development tacking information 114 via any type of web/internet protocol. Similarly, the productivity tracking unit 116 may receive the development tracking information 114 and store this information in the database associated with storing the development tracking information 114, store this information in the database associated with storing the user productivity model 102, or any other database associated with the system 100.

Also, the productivity tracking unit 116 may track user productivity across multiple versions of the development tools 124. For example, a new development tool 124 (or new version of the development tool 124) may be developed, tested, and/or released. The productivity tracking unit 116 may receive development tracking information 114 related to the new version, and compare the user productivity of this new version with previous version(s) or future version(s). In other words, the productivity tracking unit 116 may provide an effective mechanism that allows benchmarking between multiple versions, and provides valuable insight into the user productivity across the multiple versions.

In one example, the productivity tracking unit 116 may receive first development tracking information 114 related to a first version, and store this information in one of the databases associated with the system 100. Then, after a subsequent version has been developed, the productivity tracking unit 116 may receive second development tracking information 114 related to a second version, and store this information in one of the database associated with the system 100. The productivity tracking unit 116 may repeat this process for any number of versions. Then, the report generator unit 120 may compare the first development tracking information 114 and the second development tracking information 114 (as well as any other development tracking information 114 associated with other versions), and determine whether the process of the development tools 124 have increased or decreased in terms of user productivity, as further explained later in the disclosure.

The report generator unit 120 may be configured to generate at least one report 128 characterizing the user productivity in developing at least a portion of the business process based on the user productivity model 102 and the received development tracking information 114. For example, the report generator unit 120 may analyze the development tracking information 114 (which tracks user efforts across the effort drivers 110), and may create one or more reports 128 based on the development tracking information 114, as well as the user productivity model 102.

In one example, the report generator unit 120 may analyze the development tracking information 114 within the context of the user productivity model 102, and generate reports identifying the quality and robustness of the development tools 124 that assist in improving user productivity. For example, the report generator unit 120 may analyze the time across the effort drivers 110, and develop one or more reports 128 that characterize the total development effort, development effort categorized by composition pattern 108 or effort driver 110, development effort across multiple versions of the development tools 124.

Further, the report generator unit 120 may obtain additional information 118 such as user roles, team information identifying a group of users, and organization information indicating one or more organization departments, and analyze the development tracking information 114 in view of the additional information 118 to produce one or more reports that characterizes the user productivity across user roles, developmental teams, or organizational units. However, the additional information 118 may include any other type of information (in addition to the development tracking information 114 and/or the user productivity model 102) that may be used to create one or more report 128. As such, the report generator unit 120 may incorporate any type of information related to assessing user productivity, and generate reports based on this information and the development tracking information 114.

FIG. 4 illustrates an example of a report 128 including a graph 400 generated by the report generator unit 120 according to an embodiment. Also, based on the development tracking information 114 and the user productivity model 102, the report generator unit 120 may generate the following report shown in Table 2.

TABLE 2

| | Development | | | |
|---|---|---|---|---|
| | Effort (hours) - | Target | Actual | Target |
| Area | Baseline | (V1) | (V1) | (V2) |
| Set up, Admin | 40 | 30 | 46 | 20 |
| Development | | | | |
| Process | 117 | 75-90 | 42 | 30 |
| UI | 200 | 100-125 | 142 | 75-100 |
| Services | 174 | 75-100 | 142 | 30 |
| Cross Stack | 99 | 60-85 | 56 | <50 |
| P2D Handover | 60 | 60 | 79 | 50 |
| Issues | 152 | 50 | 192 | <50 |
| Project | 227 | 227 | 163 | 150 |
| Management | | | | |
| Tool learning | 95 | 95 | 35 | <50 |
| Solution | 558 | 558 | 558 | 558 |
| management | | | | |
| Total | 1721 | 1395 | 1436 | 1000 |

In this example, the different areas in Table 2 may represent higher-level categories representing groups of composition patterns 108. For example, the report generator unit 120 may define a higher-level category as development, and this higher-level group may have sub-categories such as process, UI, services, and cross stack. Each of the higher-level categories or sub-categories encompasses the relevant composition patterns 108. In particular, the process sub-category reflects the composition patterns 108 relating to the process. As such, the report generator unit 120 aggregates the development tracking information 114 as related to this sub-category so that a reviewer can see the larger picture in terms of potential problems and/or bottlenecks associated with the user productivity in using the development tools 124 for implementing at least a portion of the main process 104.

In addition, the report generator unit 120 may generate a report 128 that provides insight into different versions of the development tool 124 in order to assess whether a subsequent version has improved or decreased user productivity. For example, as shown in Table 2, the report 128 identifies the development effort with respect to a baseline version, targeted development effort for a subsequent version (V1), the actual development effort for the subsequent version (V1), and the targeted development effort for another version (V2), which tracks the development effort in terms of hours.

In this case, the productivity tracking unit 116 may receive first development tracking information 114 related to the first version of the development tool 124. Then, at a later point, the productivity tracking unit 116 may receive second development tracking information 114 related to the second version of the development tool 124. Then, the report generator unit 120 may be configured to generate a report 128 identifying the development effort categorized by the composition patterns 108 or higher-level categories representing groups of composition patterns 108 for the first version and the second version. Referring to FIG. 4, the graph 400 may graphically represent the development effort across the sub-categories (e.g., process, UI, services, cross stack) with respect to the first version and the second version. In this manner, a reviewer may be able to determine whether the second version has improved or decreased user productivity.

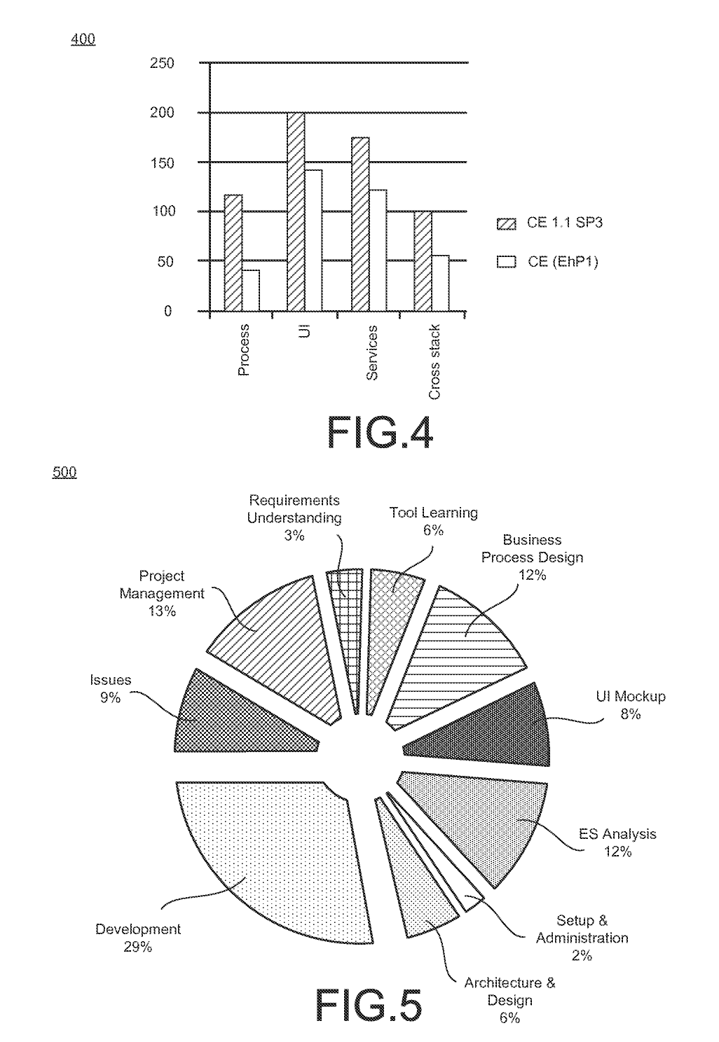

FIG. 5 illustrates an example of another report 128 including a graph 500 generated by the report generator unit 120 according to another embodiment. The report generator unit 120 may generate a report 128, as shown in the following table, which identifies at least a group of composition patterns 108 related to implementation of a portion of the main process 104.

TABLE 3
Composition Patterns 108

Process Design
Process Initation
Dynamic assignment of processor
Collaboration (Email and Form)
Dynamic parallel sub-processes
View Design
Value Help
Free style UI
Object worklists (Workflow inbox, query driven)
UI floorplans (Guided + Quick activity, Object instance)
Embedded analytics
Navigation across applications
Services, Logic
Service adaptation
Service consumption
Pure composite BO (No backend replication)
Backend BO enrichment
Document management
Cross-Stack
Implementation redirection (e.g., BE abstraction)
Business configuration
Refactoring (e.g., add field to CAF service & adapt UI)
Application skeleton (e.g., RPAU)
Top down creation

Referring to FIG. 5, the graph 500 may specify an amount of effort categorized by the plurality of effort drivers 110 for at least one group of composition patterns 108 as shown in Table 3. In this example graph 500, the report generator unit 120 may calculate the amount of effort spent for each effort driver 110 across the group of composition patterns 108, and provide the percentage of effort spent in terms of the overall development effort. In this manner, a reviewer would be able to determine if one type of effort driver 110 is more problematic than others, so that the appropriate amount of resources may be allocated to address parts of the appropriate development tools 124. Without this type of information, developers may over optimize portions of development tools 124 without addressing the real issuing causing the user productivity levels.

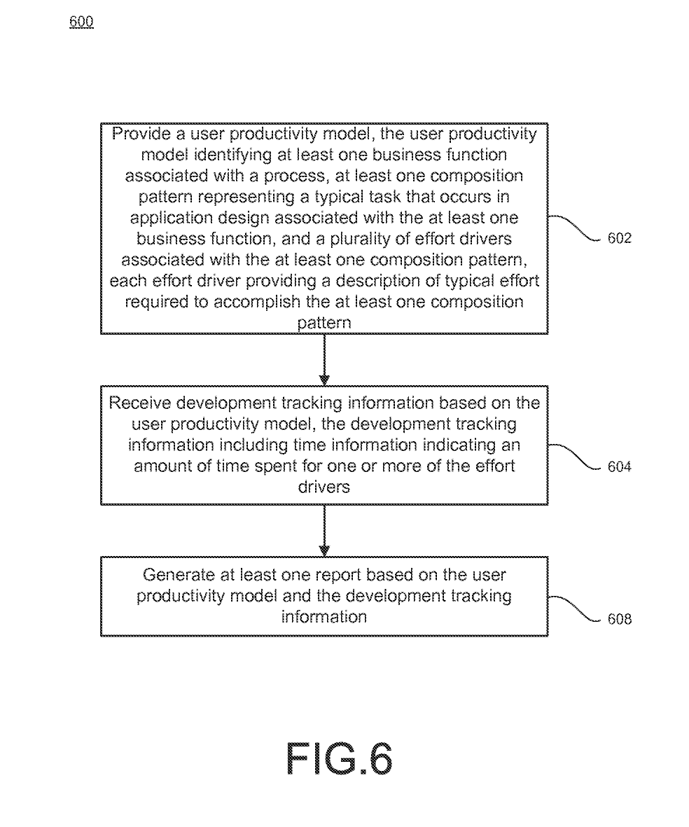

FIG. 6 is a flowchart illustrating example operations of the system 100 of FIG. 1 according to an embodiment. Although FIG. 6 is illustrated as a sequential, ordered listing of operations, it will be appreciated that some or all of the operations may occur in a different order, or in parallel, or iteratively, or may overlap in time.

A user productivity model may be provided, where the user productivity model identifies at least one business function associated with a process, at least one composition pattern representing a typical task that occurs in application design associated with the at least one business function, and a plurality of effort drivers associated with the at least one composition pattern, and each effort driver provides a description of typical effort required to accomplish the at least one composition pattern (602). For example, the productivity tracking unit 116 may provide the user productivity model 102 (or a portion thereof) to one or more computing devices 122. The user productivity model 102 may identify at least one business function 106, at least one composition pattern 108 associated with the at least one composition pattern 108, and a plurality of effort drivers 110 associated with the at least one composition pattern 108. Each effort driver may provide a description of typical effort required to accomplish the at least one composition pattern 108.

For example, as shown in FIG. 1, the user productivity model 102 may include the main process 104, the tasks 107, the business functions 106, the composition patterns 108, and/or the effort drivers 110. Also, it is noted that the user productivity model 102 may include other types of information such as tool information indicating the relevant development tool 124, as well as other information such as mapping information that maps the above-described information to each other.

Each business function 106 may be a standardized step, action, or function to develop one or more portions of the main process 104. In this context, some of the business functions 106 may be applicable across different portions of the main process 104, as well as other main processes 104. Each composition pattern 108 may provide a typical issue/problem/solution that regularly occurs in composite application design and development. In other words, a composition pattern 108 may describe a typical task which regularly occurs in application design and development. The specific type of composition pattern may widely vary depending on the context of the main process 104 to be implemented. Also, a composition pattern 108 may describe a practice (e.g., best practice) how to accomplish that task via a solution sketch and a reference implementation. each composition pattern 108 is associated with a set of effort drivers 110. The effort drivers 110 may describe the typical effort required by the development tools 124 for implementing each composition pattern 108 and/or the internal and external factors that impact the effort in implementation of each composition pattern 108. In other words, each effort driver 110 may describe the physical or mental energy provided by a user to implement a particular composition pattern 108 using one or more of the development tools 124.

In one example, the productivity tracking unit 116 may provide the user productivity model 102 to one or more computing devices 122. In one example, the productivity tracking unit 116 may provide the user productivity model 102, over a network (e.g., any conventional wired or wireless communication network), to one or more of the computing devices 122 associated with the relevant users, e.g., developers, administrators, managers, etc. In another embodiment, the productivity tracking unit 116 may provide access to the user productivity model 102 which is stored in the database associated with the system 100.

Development tracking information may be received based on the user productivity model, where the development tracking information may include time information indicating an amount of time spent for one or more of the effort drivers (604). For example, the productivity tracking unit 116 may receive the development tracking information 114 based on the user productivity model 102. The development tracking information may include time information indicating an amount of time spent for one or more of the effort drivers 110.

For example, after the user productivity model 102 is accessed at the computing devices 122, the relevant users may provide the development tracking information 114, e.g., the effort in hours, and the remarks, within the context of the user productivity model 102, via the user interface 126. In one example, if the user productivity model 102 is in the Excel spreadsheet format, the user productivity model 102 may be displayed to the user via the user interface 126, and the user may complete the effort in hours and the remarks sections for one or more of the effort drivers 110. For example, if the user has spent 10 hours related to the requirements understanding, the user would enter 10 hours in the Excel spreadsheet associated with the requirements understanding effort driver. Similarly, the user would enter time information for any other relevant effort driver. It is noted that the time information may be specified in other formats besides hours. Also, the user productivity model 102 may be in another format such as any type of spreadsheet format (other than Excel), any type of computer-file format, or any type of computer or network-based format that may be communicated over a network.

Then, the user would submit the user productivity model 102 completed with the development tracking information 114. Accordingly, the productivity tracking unit 116 may receive the development tracking information 114 and store this information in the database associated with storing the development tracking information 114, store this information in the database associated with storing the user productivity model 102, or store this information in any type of database associated with the system 100.

If the user productivity model 102 is within a network-based format, the user may be presented with the user productivity model 102, and then submit the development tacking information 114 via any type of web/internet protocol. Similarly, the productivity tracking unit 116 may receive the development tracking information 114 and store this information in the database associated with storing the development tracking information 114, store this information in the database associated with storing the user productivity model 102, or any other database associated with the system 100.

At least one report may be generated based on the user productivity model and the development tracking information (608). For example, the report generator unit 120 may be configured to generate at least one report 128 based on the user productivity model 102 and the development tracking information 114.

The report generator unit 120 may be configured to generate at least one report 128 characterizing the user productivity in developing at least a portion of the business process based on the user productivity model 102 and the received development tracking information 114. For example, the report generator unit 120 may analyze the development tracking information 114 (which tracks user efforts across the effort drivers 110), and may create one or more reports 128 based on the development tracking information 114, as well as the user productivity model 102.

In one example, the report generator unit 120 may analyze the development tracking information 114 within the context of the user productivity model 102, and generate reports identifying the quality and robustness of the development tools 124 that assist in improving user productivity. For example, the report generator unit 120 may analyze the time across the effort drivers 110, and develop one or more reports 128 that characterize the total development effort, development effort categorized by composition pattern 108 or effort driver 110, development effort across multiple versions of the development tools 124.

Various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system for measuring user productivity in developing a business process using one or more development tools, the system comprising:
at least one processor;
a non-transitory computer-readable storage medium including instructions executable by the at least one processor, the instructions configured to implement,
a productivity tacking unit configured to provide a user productivity model for measuring user productivity, the user productivity model identifying at least one business function associated with a process to be implemented by one or more development tools, at least one composition pattern representing a typical task that occurs in application design associated with the at least one business function, and a plurality of effort drivers associated with the at least one composition pattern, each effort driver providing a different characterization of effort required by a development tool to accomplish the at least one composition pattern, and
the productivity tracking unit configured to receive development tracking information based on the user productivity model, the development tracking information including time information indicating an amount of time spent for one or more of the plurality of effort drivers; and
a report generator unit configured to generate at least one report characterizing the user productivity in developing at least a portion of the process based on the user productivity model and the development tracking information.

2. The system of claim 1, wherein the user productivity model also indicates a development tool used for implementing the at least one composition pattern.

3. The system of claim 1, wherein the user productivity model is provided in an Excel format.

4. The system of claim 3, wherein the productivity tracking unit is configured to receive development tracking information embedded in the Excel format of the user productivity model.

5. The system of claim 1, wherein the plurality of effort drivers include a first effort driver related to requirements understanding, a second effort driver related to architecture or design of the process, and a third effort driver related to development of business logic for the process, and the time information indicates the amount of time spent by a user for the requirements understanding, the architecture or design of the process, and the development of business logic for the process.

6. The system of claim 1, wherein the report generator unit is further configured to receive additional information related to at least one of user roles, team information identifying a group of users, and organizational information indicating one or more organizational departments, and the report generator unit is configured to generate the at least one report based on the additional information, the user productivity model, and the development tracking information.

7. The system of claim 1, wherein the productivity tracking unit is configured to receive first development tracking information related to first version of a development tool and second development tracking information related to a second version of a development tool, and the report generator unit is configured to generate a report identifying development effort categorized by composition patterns or higher-level categories representing groups of composition patterns for the first version and the second version.

8. The system of claim 1, wherein the at least one report includes a report specifying an amount of effort categorized by the plurality of effort drivers for at least one group of composition patterns.

9. A method for measuring user productivity in developing a business process using one or more development tools, the method comprising:
providing a user productivity model for measuring user productivity, the user productivity model identifying at least one business function associated with a process to be implemented by one or more development tools, at least one composition pattern representing a typical task that occurs in application design associated with the at least one business function, and a plurality of effort drivers associated with the at least one composition pattern, each effort driver providing a different characterization of effort required by a development tool to accomplish the at least one composition pattern;
receiving development tracking information based on the user productivity model, the development tracking information including time information indicating an amount of time spent for one or more of the plurality of effort drivers; and
generating at least one report characterizing the user productivity in developing at least a portion of the process based on the user productivity model and the development tracking information.

10. The method of claim 9, wherein the user productivity model is provided in an Excel format, and the receiving step receives the development tracking information embedded in the Excel format of the user productivity model.

11. The method of claim 9, wherein the plurality of effort drivers include a first effort driver related to requirements understanding, a second effort driver related to architecture or design of the process, and a third effort driver related to development of business logic for the process, and the time information indicates the amount of time spent by one or more users for the requirements understanding, the architecture or design of the process, and the development of business logic for the process.

12. The method of claim 9, further comprising:
receiving additional information related to at least one of user roles, team information identifying a group of users, and organizational information indicating one or more organizational departments,
wherein the generating step generates the at least one report based on the additional information, the user productivity model, and the development tracking information.

13. The method of claim 9, wherein the receiving step receives first development tracking information related to first version of a development tool and second development tracking information related to a second version of a development tool, and the generating step generates a report identifying development effort categorized by composition patterns or higher-level categories representing groups of composition patterns for the first version and the second version.

14. The method of claim 9, wherein the at least one report includes a report specifying an amount of effort categorized by the plurality of effort drivers for at least one group of composition patterns.

15. The method of claim 9, the user productivity model also indicates a development tool used for implementing the at least one composition pattern.

16. A non-transitory computer-readable medium storing instructions that when executed cause a system to:
provide a user productivity model for measuring user productivity, the user productivity model identifying at least one business function associated with a process to be implemented by one or more development tools, at least one composition pattern representing a typical task that occurs in application design associated with the at least one business function, and a plurality of effort drivers associated with the at least one composition pattern, each effort driver providing a different characterization of effort required by a development tool to accomplish the at least one composition pattern;
receive development tracking information based on the user productivity model, the development tracking information including time information indicating an amount of time spent for one or more of the plurality of effort drivers; and
generate at least one report characterizing the user productivity in developing at least a portion of the process based on the user productivity model and the development tracking information.

17. The non-transitory computer-readable medium of claim 16, wherein the user productivity model is provided in an Excel format, and the instructions include instructions to receive development tracking information embedded in the Excel format of the user productivity model.

18. The non-transitory computer-readable medium of claim 16, wherein the plurality of effort drivers include a first effort driver related to requirements understanding, a second effort driver related to architecture or design of the process, and a third effort driver related to development of business logic for the process, and the time information indicates the amount of time spent by a user for the requirements understanding, the architecture or design of the process, and the development of business logic for the process.

19. The non-transitory computer-readable medium of claim 16, further comprising instructions to:
receive additional information related to at least one of user roles, team information identifying a group of users, and organizational information indicating one or more organizational departments; and
generate the at least one report based on the additional information, the user productivity model, and the development tracking information.

20. The non-transitory computer-readable medium of claim 16, wherein the at least one report includes a report specifying an amount of effort categorized by the plurality of effort drivers for at least one group of composition patterns.
